(19) United States
(12) Patent Application Publication
(10) Pub. No.: US 2003/0098850 A1
(43) Pub. Date: May 29, 2003

(54) Multi-recharging models for wireless computer mouse

(76) Inventor: Yen Jzuhsiang, Taipei Hsien (TW)

Correspondence Address: BACON & THOMAS, PLLC, 625 SLATERS LANE, FOURTH FLOOR, ALEXANDRIA, VA, 22314

(21) Appl. No.: 09/994,067

(22) Filed: Nov. 27, 2001

(51) Int. Cl. G09G 5/08

(52) U.S. Cl. 345/163

(57) ABSTRACT

The present invention relates to multi-recharging models for wireless computer mouse, especially using different power sources according to different environmental status. The recharging methods for wireless computer mouse can be divided into two kinds namely a receiving recharging model and a plugging port recharging model. If there is only one plugging port (PS2 or USB) for the receiving recharging model, the computer mouse is connected to the charger found inside the receiver during recharging period such that the storage battery inside the computer mouse is being recharged. For the plugging port (PS2 and USB), recharging model differs according to whether charger is found inside the computer mouse or not in order to determine if the connecting wire requires a charger. Hence, the present invention provides more choices for wireless personal computers while decreasing cost of production and increasing efficiency.

### TECHNICAL RANGE

The present invention relates to multi-recharging models for wireless computer mouse, especially using different power sources according to different environmental status.

### INVENTION BACKGROUND

Generally, the primary problem which has to be solved while using a wireless computer mouse is to provide a recharging power source since the wireless computer mouse is not connected to the computer.

The above-mentioned problem is usually solved by including batteries in the wireless mouse but since batteries are rapidly consumed, it is quite a disadvantage as power has to be cut off each time the batteries are being changed. Hence, much improvement is needed in order to obviate the above-mentioned drawbacks.

### SUMMARY OF INVENTION

It is an object of the present invention to provide multi-recharging models for wireless computer mouse namely a receiving recharging model and a plugging port recharging model, hence avoiding use of batteries.

According to the present invention of multi-recharging models for wireless computer mouse, if there is only one plugging port (PS2 or USB) for the receiving recharging model, the computer mouse is connected to the charger found inside the receiver during recharging period such that the storage battery inside the computer mouse is being recharged.

According to the present invention of multi-recharging models for wireless computer mouse, recharging model differs for the plugging port (PS2 and USB port) according to whether the charger is found inside the computer mouse or not in order to determine if connecting wire requires a charger.

### DESCRIPTION OF DRAWINGS

FIG. 1 shows a plan of the receiving recharging model.

FIG. 2 shows a plan of the plugging port recharging model.

FIG. 3 shows another plan of the plugging port recharging model.

### NUMERICALS

10-PS2 or 11-USB port

12-wireless signal) receiver 13-charger

14-connecting wire 15-computer mouse

16-storage battery

### MODE FOR CARRYING OUT INVENTION

The present invention relates to multi-recharging models for wireless computer mouse, mainly a receiving recharging model and a plugging port recharging model.

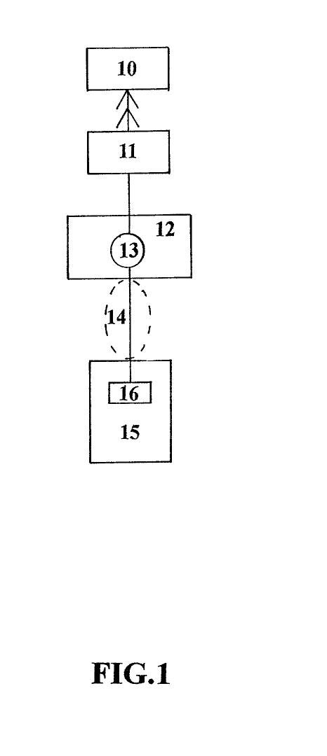

With reference to FIG. 1 showing a plan of the receiving recharging model, unique plugging port PS2 10 or USB port 11 is connected to the charger 13 found inside the wireless signal receiver 12 by means of a connecting wire 14 such that the storage battery 16 of the computer mouse 15 is being recharged during recharging period. Hence, cutting of power in order to change batteries is a avoided.

The present invention mentioned above of a plugging port (PS2 port 10 and USB port 11) recharging model differs according to whether charger 13 is found inside the computer mouse 15 or not in order to determine if connecting wire 14 requires a charger 13.

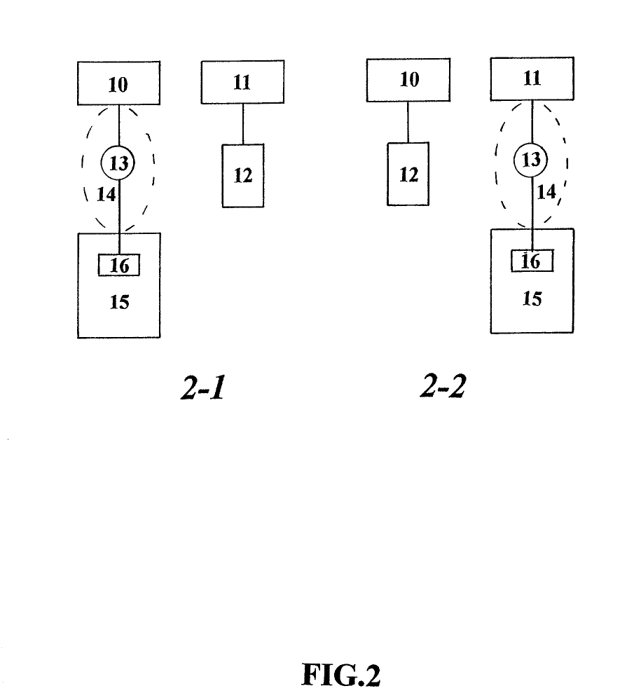

With further reference to FIG. 2 showing a plan of the plugging recharging model, FIG. 2-1 relates to the connecting wire 14 equipped with a charger 13 plugged to PS2 port 10 at one end and connected to the storage battery 16 of the computer mouse 15 at the other end, matched with a wireless signal receiver 12 plugged to USB port 11 at one end and connected to the storage battery 16 of the computer mouse 15 at the other end, matched with a wireless signal receiver 12 plugged to PS2 port 10.

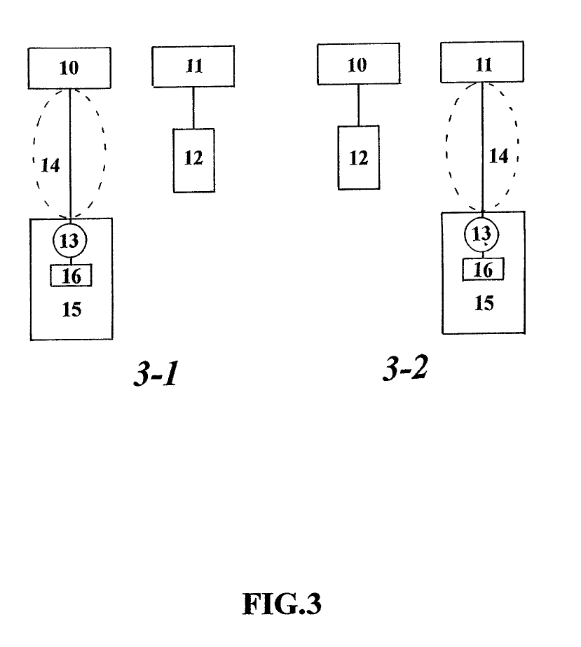

With more reference to FIG. 3 showing another plan of the plugging port recharging model, the connecting wire 14 shown in FIG. 3-1 is connected to PS2 port 10 at one end and connected to the charger 13 and storage battery 16 of the computer mouse 15 at the other end, matched with a wireless signal receiver 12 plugged to USB port 11; or, as shown in FIG. 3-2 wherein the connecting wire 14 is plugged to USB port 11 and connected to the charger 13 and storage battery 16 of the computer mouse 15 at the other end, matched with a wireless signal receiver 12 plugged to PS2 port 10. Hence, the present invention provides more choices for wireless personal computers while decreasing cost of production and increasing efficiency.

1. A kind of multi-recharging models for wireless computer mouse, namely a receiving recharging model and a plugging recharging model wherein:
if there is only one plugging port (PS2 port or USB port) for the receiving recharging model, the computer mouse is connected to the charger found inside the receiver during recharging period such that the storage battery inside the computer mouse is being recharged;
recharging model differs for the plugging port recharging model according to whether charger is found inside the computer mouse or not in order to determine if connecting wire requires a charger.

2. As mentioned in claim 1 of a “Multi-recharging models for wireless computer mouse”, if there is only one plugging port PS2 or USB for the receiving recharging model, the wireless mouse to connected to the charger found inside the wireless signal receiver by means of connecting wire such that the storage battery of the computer mouse is being recharged.

3. As mentioned in claim 1 of a “Multi-recharging models for wireless computer mouse”, the plugging port recharging model consists of a connecting wire equipped with a charger plugged to PS2 or USB port at one end and connected to the storage battery of the computer mouse at the other end, matched with each wireless signal receiver plugged to USB or PS2 port.

4. As mentioned in claim 1 or 3 of a “Multi-recharging models for wireless computer mouse”, the plugging port recharging model consists of a connecting wire without a charger plugged to PS2 or USB port at one end connected to the charger and storage battery of the computer mouse at the other end, matched with a wireless signal receiver plugged to USB or PS2 port.
